(19) United States
(12) Patent Application Publication
(10) Pub. No.: US 2022/0360139 A1
(43) Pub. Date: Nov. 10, 2022

(54) METHOD FOR MINIMIZING GENERATOR VIBRATIONS

(71) Applicant: Wobben Properties GmbH, Aurich (DE)

(72) Inventors: Jair CASSOLI, Aurich (DE); Roberto ROSSO, Aurich (DE)

(21) Appl. No.: 17/622,644

(22) PCT Filed: Jun. 25, 2020
(86) PCT No.: PCT/EP2020/067815

§ 371 Date: Dec. 23, 2021

(30) Foreign Application Priority Data
Jun. 28, 2019 (DE) 10 2019 117 477.5

(51) Int. Cl. H02K 7/18; F03D 9/25; H02P 21/10; H02P 21/05

(52) U.S. Cl. CPC H02K 7/183; F03D 9/25; H02P 21/10; H02P 21/05; H02P 2101/15

(57) ABSTRACT

Provided is a method for controlling an active rectifier connected to a stator of a wind power installation using field-oriented control. The generator comprises a stator having an axis of rotation around which the rotor is mounted. The method includes predefining rotor-fixed d and q coordinates for at least one 3-phase stator current of the generator and determining at least one alternating component for the rotor-fixed d and/or q coordinate depending on a detected amplitude and detected phase position of an electrical power oscillation on the generator and taking account of a rotor position representing a mechanical position of the rotor in relation to the stator. The method includes adding the alternating component for the rotor-fixed d and/or q coordinate to the rotor-fixed d and/or q coordinate to form a modified d and/or q coordinate, and controlling the active rectifier at least depending on the modified d and/or q coordinate.

### BACKGROUND

### Technical Field

The present invention relates to a method for controlling a wind power installation, a controller of a wind power installation, and a wind power installation of this type.

### Description of the Related Art

Wind power installations normally have a generator which is essentially formed from a stator and a rotor. An air gap is further present between the stator and the rotor.

An uneven air gap of the generator, which is caused, for example, by component tolerances, can cause the amplitude of the induced synchronous generated voltage on the stator windings to have vibrations at the mechanical frequency of the rotor.

These vibrations can result in air gap power oscillations at the same frequency, which can in turn result in increased sound emissions and/or tower vibrations.

The German Patent and Trademark Office has identified the following prior art in the priority application for the present application: EP 2 485 388 A1, EP 3 010 143 A1, EP 3 454 469 A1, EP 3 297 156 A1 and article by Nezar ABOU-QAMAR et al.: “Cancellation of harmonic torque disturbance in permanent magnet synchronous motor drives by using an adaptive feedforward controller,” in: ET Power Electronics, Vol. 11, 2018, Iss. 14, pp, 2215-2221.-ISSN 1755-4535.

### BRIEF SUMMARY

One or more embodiments are directed to reducing oscillations in the electrical power of a generator, particularly those which are caused by an uneven air gap.

Provided is a method for controlling an active rectifier connected to a stator of a wind power installation which is controlled by means of a field-oriented control, wherein the generator comprises a stator having an axis of rotation around which the rotor is mounted.

The generator is preferably designed as an internal rotor, particularly preferably as a 6-phase generator with two 3-phase systems shifted by 30° in relation to one another.

According to the proposed method, rotor-fixed d and q coordinates are predefined in a first step for at least one 3-phase stator current of the generator. This can be done, for example, by means of any dq transformation method such as, for example, a dq transformation method comprising an MEPA (Maximum Efficiency per Ampere) method.

In a further, preferably simultaneous step, at least one alternating component for the rotor-fixed d and/or q coordinate is determined depending on a detected amplitude and a detected phase position of an electrical power oscillation on the generator.

The alternating component for the fixed-rotor d and/or q coordinate is preferably determined, taking into account a rotor position which represents a mechanical position of the rotor in relation to the stator.

It is therefore proposed, in particular, to generate an alternating component for a d and/or q coordinate depending on a mechanical rotor position.

In a further step, the alternating component for the rotor-fixed d and/or q coordinate is then added to the rotor-fixed d and/or q coordinate, in particular to form a modified d and/or q coordinate.

It is therefore also proposed, in particular, to complement a direct component of a d and/or q coordinate with an alternating component of a d and/or q coordinate in such a way that a modified d and/or q coordinate is produced which has both a direct component and an alternating component.

The active rectifier is then controlled at least depending on this modified d and/or q coordinate.

This is preferably done through repeated transformation of the modified d and/or q coordinate into abc coordinates. The rectifier is preferably controlled by means of a field-oriented control.

Provided is a control method which reduces the electrical power oscillations in the mechanical frequency range.

As a result, it is also possible to minimize vibration effects and acoustic effects on the generator, particularly those which are caused by an irregular air gap.

The alternating component for the rotor-fixed d and/or q coordinate is preferably generated depending on the rotor position.

It is therefore also proposed to take into account the mechanical rotor position of the generator.

It is particularly advantageous here that an extremely precise control can thereby be performed which can reduce the vibration effects and acoustic effects on the generator in such a way that any resulting tower vibrations can be reduced.

A torque-forming component is preferably controlled to zero, in particular by means of a proportional-integral (PI) controller, in order to determine the alternating component for the d and/or q coordinate.

It is therefore also proposed, in particular, to design the method in such a way that the torque-forming q component is controlled to zero.

Through the use of a PI controller, it is furthermore possible to replicate the mechanical irregularity of the air gap electrically in such a way that this mechanical interference no longer has any electrical significance.

It is therefore also proposed, in particular, to smooth the mechanical irregularity of the air gap electrically.

A field-forming component is preferably preset to zero in order to determine the alternating component for the rotor-fixed d and/or q coordinate.

An actual power output by the generator and a mechanical frequency of the generator are preferably determined in order to detect the amplitude and the phase position of the electrical power oscillation on the generator.

This can be done, for example, using measurement means which are arranged on the generator.

The alternating component for the rotor-fixed d and/or q coordinate is preferably obtained from αβ coordinates.

It is therefore also proposed, in particular, to obtain the d and/or q coordinates from αβ coordinates.

This can be done, for example, by means of a transformation by a transformation unit.

The active rectifier is preferably controlled by means of abc coordinates, particularly in such a way that generator vibration and/or tower vibration is/are reduced as a result.

A control unit (e.g., controller) of a wind power installation is further proposed, wherein the wind power installation has at least one generator which comprises a stator having an axis of rotation around which a rotor is mounted, wherein the stator is electrically connected to an active rectifier which is drivable via a drive unit, comprising at least a first calculation unit to predefine rotor-fixed d and q coordinates for at least one 3-phase stator current of the generator; a second calculation unit to determine at least one alternating component for the rotor-fixed d and/or q coordinate depending on a detected amplitude and a detected phase position of an electrical power oscillation on the generator, wherein the alternating component for the rotor-fixed d and/or q coordinate is determined, taking into account a rotor position which represents a mechanical position of the rotor in relation to the stator, and a connection element which interconnects the first and the second calculation unit and is configured to add the alternating component for the rotor-fixed d and/or q coordinate to the rotor-fixed d and/or q coordinate to form a modified d and/or q coordinate.

The control unit is preferably configured to be connected to a Kalman filter and/or to the drive unit.

The control unit preferably comprises a first transformation unit which can generate a torque-forming component depending on a rotor position.

The control unit preferably further comprises a PI controller, in particular to control a torque-forming component to zero.

The control unit preferably further comprises a second transformation unit which is configured to generate an alternating component of a d and/or q coordinate, in particular one which oscillates at the mechanical frequency of the rotor, from a direct component of a d and/or q coordinate, taking account of a rotor position.

The control unit is preferably configured to carry out a method described above or below.

A wind power installation is further proposed, comprising a generator which has a stator having an axis of rotation around which a rotor is mounted, an active rectifier which is electrically connected to the stator of the wind power installation and is configured to be controlled by means of a field-oriented control, and a control unit described above or below.

In one preferred embodiment, the generator is a 6-phase generator having two 3-phase current systems offset by 30°. In such cases, the method described above and/or below is carried out for each system individually.

In one particularly preferred embodiment, the generator is designed as an internal rotor.

The wind power installation preferably comprises a Kalman filter which is connected to the control unit and furthermore or alternatively a drive unit which is configured to drive the active rectifier and which is connected to the control unit.

### BRIEF DESCRIPTION OF THE SEVERAL VIEWS OF THE DRAWINGS

The present invention will now be described in detail below by way of example on the basis of example embodiments with reference to the accompanying figures, wherein the same reference numbers are used for identical or similar assemblies.

FIG. 1 shows a schematic view of a wind power installation according to one embodiment.

FIG. 2 shows a schematic view of an electrical string of a wind power installation according to one embodiment.

FIG. 3 shows a schematic structure of a control unit of a wind power installation according to one embodiment.

FIG. 4 shows a schematic structure of a preferred part of a control unit of a wind power installation according to one embodiment.

FIG. 5 shows a schematic sequence of a method according to one embodiment.

### DETAILED DESCRIPTION

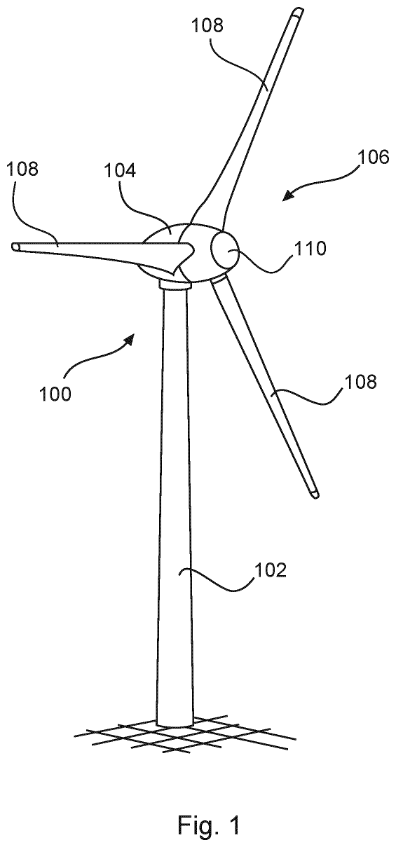

FIG. 1 shows a schematic view of a wind power installation 100 according to one embodiment.

The wind power installation 100 has a tower 102 and a nacelle 104 for this purpose. An aerodynamic rotor 106 with three rotor blades 108 and a spinner 110 is disposed on the nacelle 104. The rotor 106 is set in rotational motion by the wind during operation and thereby drives a generator in the nacelle 104.

A control unit described above or below is further provided to operate the wind power installation.

The generator further comprises a stator having an axis of rotation and a rotor which runs around this axis of rotation, preferably an internal rotor, wherein the stator is electrically connected to an active rectifier which is drivable via a drive unit.

The stator has two electrical winding systems which are phase-shifted by 30° and are connected in each case to a 3-phase module of the active rectifier. The generator is therefore designed as a 6-phase generator.

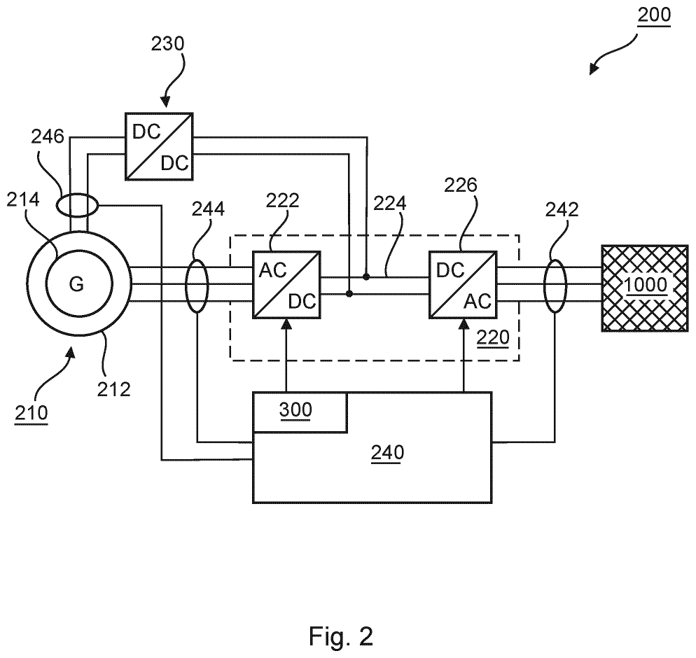

An electrical string of this type is shown in FIG. 2 in a simplified view, i.e., in particular only having a 3-phase system.

FIG. 2 shows a schematic view of an electrical stage 200 of a wind power installation according to one embodiment, in particular a wind power installation 100 as shown in FIG. 1.

The wind power installation comprises a generator 210 which is connected by means of a converter 220 to an electrical supply network 1000.

The generator 210 comprises a stator 212 having an axis of rotation and a rotor 214 mounted around the axis of rotation. The generator 210 is preferably designed as a 6-phase internal rotor.

The converter 220 comprises an active rectifier 222, a DC voltage intermediate circuit 224 and an inverter 226, wherein the converter 220 is connected by means of the active rectifier via the stator 212 to the generator 210.

An excitation (e.g., converter) 230 which is fed from the DC voltage intermediate circuit 224 is provided in order to control the electrical power generated by the generator 210. The excitation 230 preferably comprises at least one DC-DC chopper converter which is connected to the rotor 214 of the wind power installation.

A wind power installation controller 240 is further provided to control the wind power installation, and in particular the converter 220.

The wind power installation controller 240 is configured, using measurement means (current sensor, probe or clamp, ammeter or multimeter) 242, 244, 246, to detect an excitation current of the rotor 214, a generated current of the stator 212 and a generated current of the inverter 226 to control the electrical string 200 depending on the values detected in this way.

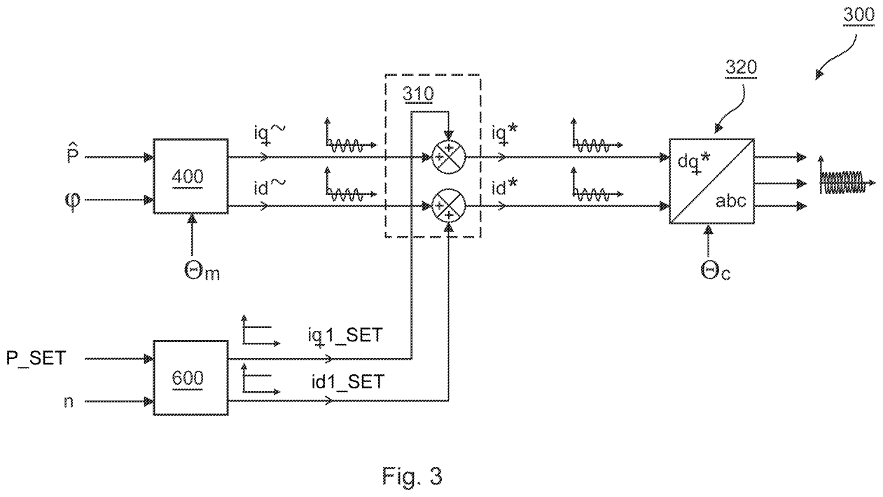

The wind power installation controller further comprises a control unit (e.g., controller) 300 described above or below, in particular as shown in FIG. 3.

FIG. 3 shows a schematic structure of a control unit 300 of a wind power installation according to one embodiment, in particular a wind power installation 100 as shown in FIG. 1.

The control unit 300 comprises a first calculation unit 600, a second calculation unit 400, a connection element 310 and preferably a drive unit 320. The control unit preferably operates with current variables i, in particular in order to drive the rectifier.

The first calculation unit 600 is provided in order to predefine rotor-fixed d and q coordinates id1_set, iq1_set for at least one 3-phase stator current of the generator, in particular of a generator as shown in FIG. 2.

The first calculation unit 600 is therefore provided at least in order to predefine rotor-fixed d and q coordinates id1_set, iq1_set in the form of a direct variable, in particular as fundamental oscillation components. The power setpoint P_set and the rotor speed n, for example, can be used as the main input variables for this purpose. The fundamental oscillation components can further be calculated, for example, by means of an algorithm in such a way that the efficiency of the generator is optimized. One example of an algorithm or optimization method of this type is the “Maximum Efficiency per Ampere” (MEPA) method.

The second calculation unit 400 is provided in order to determine at least one alternating component for the rotor-fixed d and/or q coordinate id˜, iq˜ depending on a detected amplitude \hat{P} and a detected phase position φ of an electrical power oscillation on the generator, wherein the alternating component for the rotor-fixed d and/or q coordinate id˜, iq˜ is determined taking account of a rotor position Om which represents a mechanical position of the rotor in relation to the stator.

The connection element 310 which interconnects the first and the second calculation unit is configured to add the alternating component for the rotor-fixed d and/or q coordinate id˜, iq˜ to the rotor-fixed d and/or q coordinate id1_set, iq1_set to form a modified d and/or q coordinate id*, iq*. The connection element 310 is therefore preferably designed at least as a summing point.

The modified d and/or q coordinates id*, iq* obtained in this way are then preferably transformed by means of a drive unit 320 into abc coordinates in order to drive the rectifier. This transformation is preferably performed taking account of an electrical phase position θe.

It is therefore proposed, in particular, to add an alternating component id˜, iq˜ which takes into account a mechanical rotor position Om of the generator to dq coordinates id1_set, iq1_set which are essentially formed as a direct component. The coordinates are preferably current coordinates.

By taking account of the phase position, the imbalance of the generator can be electrically compensated, resulting in a reduction in specific vibration effects and acoustic effects of the wind power installation, in particular of the generator. Tower vibrations which are caused by the generator can also be minimized by means of a method of this type.

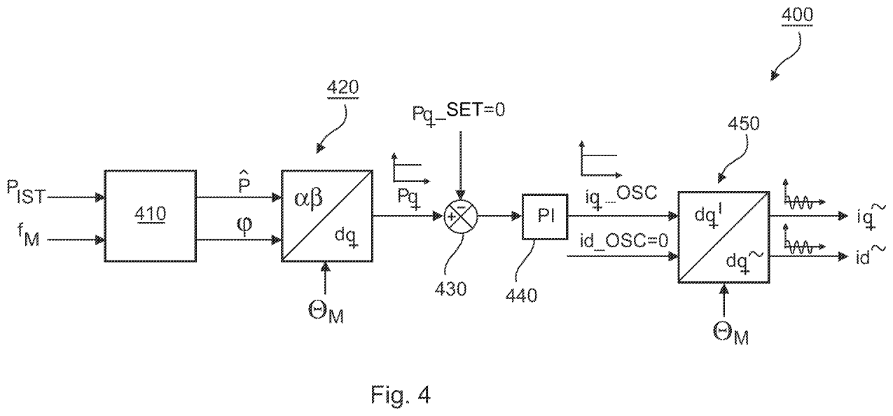

One preferred design of the second calculation unit 400 is further shown in FIG. 4.

FIG. 4 shows a schematic structure 400 of a preferred part of a control unit 300 of a wind power installation according to one embodiment, in particular a second calculation unit 400 of a control unit as shown in FIG. 3.

The second calculation unit 400 comprises a filter 410, a first transformation unit 420, a feedback (e.g., subtractor) 430, the PI controller 440 and a second transformation unit 450.

The filter 410 is preferably designed as a Kalman filter and has the electrical power Pist of the generator and the mechanical frequency fm of the generator as input variables. The Kalman filter determines an amplitude \hat{P} and a phase position φ of an electrical power oscillation from these variables. The Kalman filter itself can be regarded as an optional component. The amplitude \hat{P} and the phase position φ can also be generated in a different manner.

The first transformation unit 420 transforms dq coordinates, particularly in the form of a power coordinate Pq, from the αβ coordinates, i.e., the amplitude \hat{P} and the phase position φ. The transformation is preferably performed taking account of the mechanical rotor position θm of the generator. The first transformation unit is thus configured to generate a torque-forming component depending on a rotor position.

The power coordinate Pq obtained in this way is controlled to zero by means of a feedback 430 and a PI controller 440. The current oscillation q coordinate iq_osc obtained therefrom is fed, together with a corresponding current oscillation d coordinate id_osc=0, to the second transformation unit 450.

The second transformation unit 450 is configured to generate an alternating component of a d and/or q coordinate iq˜, id˜, particularly one that oscillates at the mechanical frequency of the rotor, from the direct component of a d and/or q coordinate iq_osc, id_osc=0 taking account of the mechanical rotor position θm.

The second calculation unit 400 is therefore configured to generate an alternating component of a d and/or q coordinate iq˜, id˜ from an electrical power Pist of the generator and a mechanical frequency fm of the generator which are added to a fundamental oscillation component, as shown, for example, in FIG. 3, in particular in order to dampen vibration effects and acoustic effects of a generator.

Provided herein is enabling the damping, in particular, of electrical power oscillations in the mechanical frequencies range, particularly those power oscillations which are caused by unevenness in the air gap.

Insofar as the generator is designed as a 6-phase generator, that is to say comprises two 3-phase systems, the method described above and/or below is applicable to each of the systems individually.

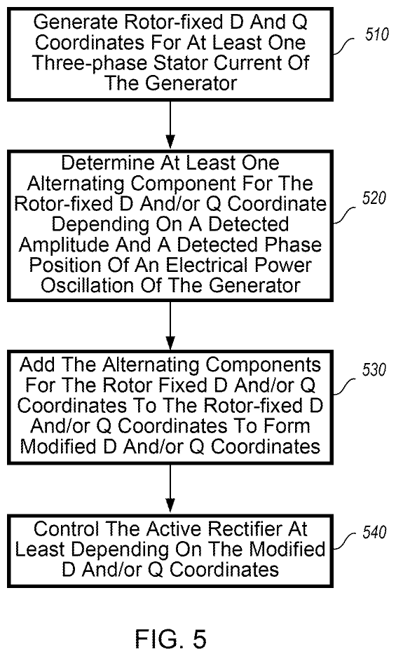

FIG. 5 shows a schematic sequence 500 of a method according to one embodiment.

In a first step, rotor-fixed d and q coordinates are generated for at least one 3-phase stator current of the generator. This is indicated by block 510.

In a further, in particular simultaneous, step, at least one alternating component for the rotor-fixed d and/or q coordinate is determined depending on a detected amplitude and a detected phase position of an electrical power oscillation on the generator, wherein the alternating component for the rotor-fixed d and/or q coordinate is determined taking account of a rotor position which represents a mechanical position of the rotor in relation to the stator. This is indicated by block 520.

In a next step, the alternating components for the rotor fixed d and/or q coordinates are added to the rotor-fixed d and/or q coordinates to form modified d and/or q coordinates. This is indicated by block 530.

Then, in a further step, the active rectifier is controlled at least depending on the modified d and/or q coordinates, in particular by means of abc coordinates. This is indicated by block 540.

1. A method for controlling an active rectifier using field-oriented control,
wherein:
a generator of a wind power installation includes a stator and a rotor,
the stator has an axis of rotation, and
the active rectifier is coupled to the stator, and
the method comprises:
setting rotor-fixed d and q coordinates for at least one three-phase stator current of the generator;
determining at least one alternating component for the rotor-fixed d and/or q coordinate depending on a detected amplitude and a detected phase position of an electrical power oscillation of the generator, wherein the at least one alternating component for the rotor-fixed d and/or q coordinate is determined based on a rotor position representing a mechanical position of the rotor in relation to the stator;
adding the at least one alternating component for the rotor-fixed d and/or q coordinate and the rotor-fixed d and/or q coordinate to produce a modified d and/or q coordinate; and
controlling the active rectifier at least depending on the modified d and/or q coordinate.

2. The method as claimed in claim 1, comprising:
generating the at least one alternating component for the rotor-fixed d and/or q coordinate depending on the rotor position.

3. The method as claimed in claim 1, comprising:
setting a torque-forming component to zero.

4. The method as claimed in claim 1, comprising:
setting a field-forming component to zero to determine the at least one alternating component for the rotor-fixed d and/or q coordinate.

5. The method as claimed in claim 1, comprising:
determining a power that is output by the generator and a mechanical frequency of the generator to detect the amplitude and the phase position of the electrical power oscillation of the generator.

6. The method as claimed in claim 1, comprising:
obtaining the alternating component for the rotor-fixed d and/or q coordinate from αβ coordinates.

7. The method as claimed in claim 1, comprising:
controlling the active rectifier using abc coordinates to reduce generator vibration and/or tower vibration.

8. A controller of a wind power installation,
wherein the wind power installation includes:
at least one generator including a stator having an axis of rotation around which a rotor is mounted, wherein the stator is electrically coupled to an active rectifier configured to be driven by the controller, and
wherein the controller is configured to:
set rotor-fixed d and q coordinates for at least one three-phase stator current of the generator;
determine at least one alternating component for the rotor-fixed d and/or q coordinate depending on a detected amplitude and a detected phase position of an electrical power oscillation on the generator, wherein the at least one alternating component for the rotor-fixed d and/or q coordinate is determined based on a rotor position representing a mechanical position of the rotor in relation to the stator; and
add the at least one alternating component for the rotor-fixed d and/or q coordinate and the rotor-fixed d and/or q coordinate to form a modified d and/or q coordinate.

9. The controller as claimed in claim 8, wherein the controller includes a Kalman filter and/or drives the active rectifier.

10. The controller as claimed in claim 8, wherein the controller is configured to:
generate a torque-forming component depending on the rotor position.

11. The controller as claimed in claim 8, wherein the controller is configured to operate as a proportional-integral (PI) controller to control a torque-forming component to zero.

12. The controller as claimed in claim 8, wherein the controller is configured to generate the at least one alternating component of a d and/or q coordinate that oscillates at a mechanical frequency of the rotor from a direct component of a d and/or q coordinate and based on the rotor position.

13. (canceled)

14. A wind power installation, comprising:
the controller as claimed in claim 8;
the generator comprising the stator having the axis of rotation around which the rotor is mounted; and
the active rectifier electrically coupled to the stator and configured to be controlled by field-oriented control.

15. The wind power installation as claimed in claim 14, wherein the controller includes a Kalman filter and/or the controller is configured to drive the active rectifier.

16. The method as claimed in claim 3, comprising:
setting the torque-forming component to zero using a proportional-integral (PI) to determine the at least one alternating component for the d and/or q coordinate.
